(19) United States
(12) Patent Application Publication
(10) Pub. No.: US 2015/0351447 A1
(43) Pub. Date: Dec. 10, 2015

(54) Chocolate Dipping Tray

(71) Applicant: Oluwaseun Ogundiran, Bowie, MD (US)

(72) Inventor: Oluwaseun Ogundiran, Bowie, MD (US)

(21) Appl. No.: 14/727,436

(22) Filed: Jun. 1, 2015

Related U.S. Application Data
(60) Provisional application No. 62/007,437, filed on Jun. 4, 2014.

(51) Int. Cl. A23P 1/08; A23L 1/212

(52) U.S. Cl. CPC A23P 1/084; A23L 1/2125; A23V 2002/00

(57) ABSTRACT

A chocolate dipping tray is described which is configured to facilitate the application of chocolate or a similar hardening confection to a fruit such as a strawberry. The tray is equipped with a series of pockets which are preferably shaped according to a specific fruit. The series of pockets are equipped with at least one horizontal line to provide a measuring basis for chocolate to be poured into the pockets prior to the insertion of a strawberry. The series of pockets may be equipped with embossed decorations such as hearts, words, shapes, logos, or other similar personalized effects.

### CONTINUITY

This application is a Non-provisional application of Provisional Patent Application No. 62/007,437, filed on Jun. 4, 2014, and priority is claimed thereto.

### FIELD OF THE PRESENT INVENTION

The present invention relates to cooking or meal preparation trays, and more specifically, trays used to facilitate the application of a sauce, syrup, chocolate, or other confection onto a fruit, nut, or vegetable.

### BACKGROUND OF THE PRESENT INVENTION

Chocolate covered strawberries are a healthy and delicious treat that dates back in popularity from centuries ago. They are a tasty snack that is popular year round, and strawberries are the most cultivated berry in the country. No matter what state of America an individual lives in, he or she will always be able to buy strawberries year round. With consumers spending a fortune at fancy chocolatier shops on these easy to make treats, especially around the commercialized holidays, as well as special occasions, consumers can easily spend $30 and up for a dozen chocolate dipped strawberries. However, why spend that much for something that is not guaranteed fresh when you can make a larger quantity at home and spend less! The freshness of a product, especially of most fruits is difficult to guarantee; but, having a product that will guarantee the freshness, design, and the convenience that an individual needs should be available to everyone.

Thus, there is a need for a chocolate covered strawberry tray to facilitate the conservation of time and money used during the process of creating chocolate covered strawberries. Such a tray would preferably provide individuals the ability to make a large quantity of covered strawberries in the same amount of time, leaving virtually no mess. The tray is to be preferably offered in a variety of colors and designs in order to suit the needs of the consumer. For example, trays could be configured to be suited for general use, weddings, Valentine's Day, Christmas, birthdays, graduations, bereavement, or to just simply say thank you. By using this invention, the user can add a personalized flair and use it as a fun yet educational activity for the user's kids, teaching them how to make eating fruit fun and delicious. Personalization of the chocolate covered strawberries that such an invention would craft would be imprinted or embossed on the chocolate covered strawberry by the mold. All consumers will be able to benefit and appreciate the appeal, versatility, and functionality that such an invention offers.

### SUMMARY OF THE PRESENT INVENTION

The present invention is a silicone rectangular shaped tray that is equipped with a series of deep pockets used to insert chocolate and strawberries of a variety of sizes in order to make a solid chocolate covered strawberry with appropriately evenly distributed chocolate. Each of the deep pockets includes measurement lines to facilitate the measurement of chocolate within each deep pocket to yield the most complete covered strawberry without using excess chocolate. In the preferred embodiment of the present invention, the core of the present invention is preferably made from food grade silicone, which is preferably flexible enough to facilitate the removal of the chocolate covered strawberries from the tray without the chocolate cracking, thus hindering the presentation as well as the resulting appearance of the strawberry. The trays of the present invention will ideally come in a variety of colors and designs on the inside of the pockets or mold portion of the tray to cater to different holidays, or to cause a shape or indentation to be molded into the chocolate that relates to the personality of the person creating it. The deep pockets of the present invention are preferably of variable shape in order to accommodate a variety of strawberry sizes.

Further personalization may be applied by using specially tailored deep pocket molds for the tray of the present invention. For example, for a Valentine's day tray can consist of a pink tray with white and red heart shapes around the tray with smaller hearts on the inside of the mold that will actually shape the three-dimensional chocolate hearts onto the strawberry upon completion of the creation of the chocolate covered strawberry.

### BRIEF DESCRIPTION OF THE DRAWINGS

FIG. 1 illustrates a side/top perspective view of the chocolate covered strawberry tray.

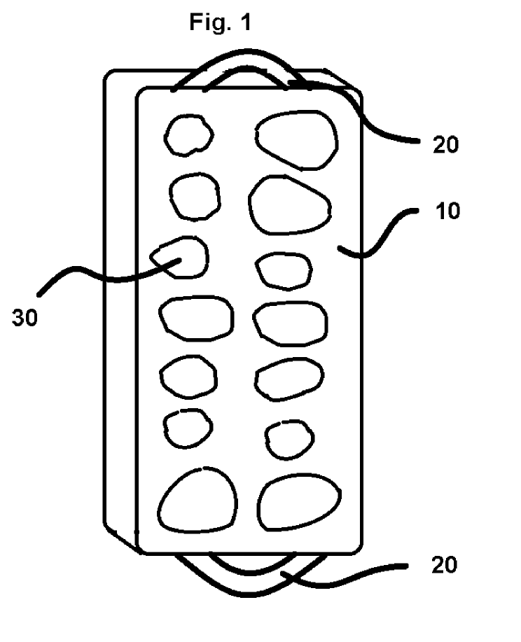

FIG. 2 illustrates a perspective view of an opening of the strawberry shaped mold, detailing the inside of the mold, where the tray is configured to receive a strawberry to be covered in chocolate.

FIG. 3 displays the present invention from the side, as though it were flat on a surface.

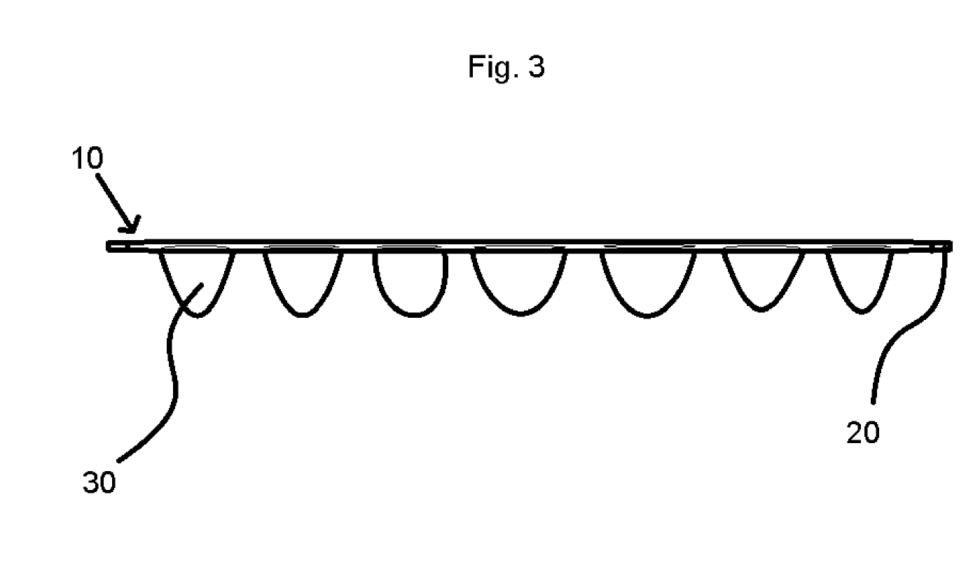

### DETAILED DESCRIPTION OF THE PREFERRED EMBODIMENT

The present invention is a tray (10) that is equipped with a series of pockets (30), each pocket of the series of pockets (30) is molded to be the shape of a strawberry. The tray (10) of the present invention is preferably rectangular in shape, and is preferably constructed of silicone or silicone covered plastic. The tray (10) of the present invention is equipped with at least one grip handle (20) on each end of the tray to prevent dropping and/or spilling the tray, and to facilitate movement of the tray when full. The series of pockets (30) are preferably strawberry shaped cups and are preferably available in a variety of designs, sizes, and colors. The consumer will have an array of options to choose from, ranging from purchasing a tray (10) that is smooth on the inside, to a variation of the tray (10) that would have seed-like ridges embossed within the series of pockets (30), or even miniature hearts on the inside of the strawberry-like cups comprising the series of pockets (30).

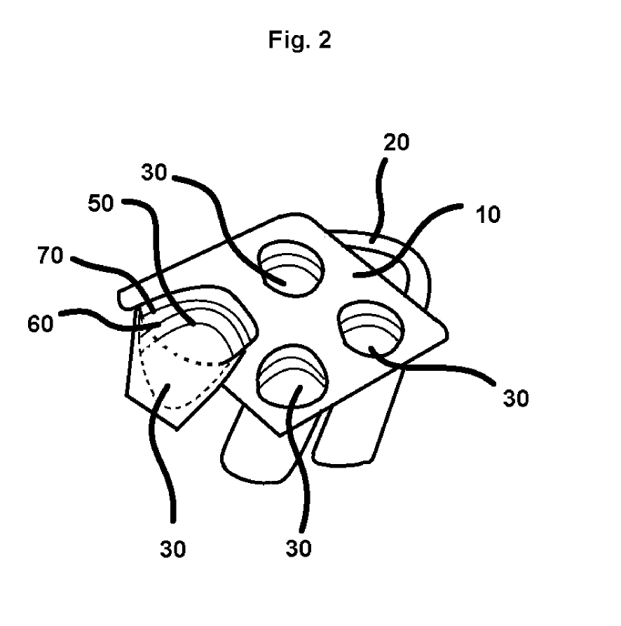

It is envisioned that a wide variety of shapes could be used as indentations within the series of pockets (30) in order to emboss or print letters, squares, circles, hearts, stars, numbers, company logos, or other emblems. It should be understood that the series of pockets (30) of the present invention constitute a mold which is preferably of a strawberry shape. Each of the pockets of the series of pockets (30) of the mold may vary in size in order to accommodate each size of strawberry. Each pocket of the series of pockets (30) is preferably demarcated with horizontal lines, which are clearly visible circumscribing the shape of the pocket within the mold of the tray (10), as seen in FIG. 2. A first horizontal line (50) lines the inner portion of each pocket of the series of pockets (30) of the present invention, and is to be used to measure the amount of chocolate needed to cover the strawberry. Some embodiments of the present invention may include multiple iterations of the horizontal line in order to demarcate the level of chocolate required to cover strawberries that vary in size.

For example, as seen in FIG. 2 a first horizontal line (50) corresponds to strawberries that fit within the pocket that correlate to smaller sized strawberry. A second horizontal line (60) may be disposed above the first horizontal line (50) in order to provide a measuring point for a medium sized strawberry to be covered with chocolate or a similar hardening confection. Other embodiments of the present invention may include a third horizontal line (70) to further demarcate the level of chocolate required to cover the largest of sized strawberries. It should be noted that the first horizontal line (50) is deeper within the series of pockets (30) than the second horizontal line (60) and the third horizontal line (70), each of which corresponding to strawberry sizes, namely small strawberries require chocolate to be filled to the first horizontal line (50). The second horizontal line (60) corresponds to medium-sized strawberries. Similarly, chocolate should be filled to the third horizontal line (70) if the strawberry or similarly sized fruit is large.

When the chocolate molds on to the strawberry within the series of pockets (30) of the tray (10) of the present invention, a three-dimensional or ‘raised’ design is preferably embossed or printed on the chocolate itself. However, if the user of the present invention chooses not to have a design on the inside on the mold, the surface of the chocolate covered strawberry will be smooth. The tray (10) of the present invention is preferably made of food grade silicone and its primary use to make the perfect chocolate covered strawberry. However, it is envisioned that the present invention could also be used to make chocolate molds, strawberry-shaped little cakes or even strawberry-shaped ice sculptures.

The tray of the present invention preferably consists of 18 different sized (small, medium, large) pockets consisting of the series of pockets (30) for the different sized strawberries. It is envisioned that a tray (10) containing more or fewer than 18 of the series of pockets (30) could be fashioned as well. The tray (10) of the present invention preferably comes with a pamphlet which provides a brief description on how to employ the tray (10) of the present invention for the best results. The pamphlet will provide instructions, as well as illustrations of a fit-to-size strawberry chart or strawberry sizing chart, by which the consumer can measure their strawberry against a series of samples in order to use the appropriately sized strawberry pocket of the series of pockets (30) of the present invention within the tray (10). It is envisioned that the consumer preferably places his or her strawberries atop the illustrated strawberries to best measure the strawberry's size and shape, and place it in to the appropriate pocket within the series of pockets (30) of the present invention according to the designation closest fitting the strawberry on the strawberry sizing chart. Based on the size and measurements each cup will contain at least one horizontal line on the interior, to delineate know how much chocolate to use in accordance with the size of the strawberry, minimizing excess chocolate use. This will ensure that the melted chocolate does not overflow onto the tray (10) and cause the finished chocolate-covered strawberries to have rough edges. Use of the tray (10) of the present invention in this fashion, in turn, yields the perfect chocolate covered strawberry.

Alternate embodiments of the present invention may include variations on the shape and/or of the series of pockets (30). For example, in an alternate embodiment of the present invention, the series of pockets (30) found on the tray (10) of the present invention may be shaped according to slices of watermelon, cubes of cheese, grapes, cherries, pears, star fruit, or other similar fruit that may be appetizing when dipped in chocolate or another hardening confection.

It should be noted that the preferred embodiment of the present invention is employed by a user as follows:

First, the user attains strawberries and sizes them according to whether they are small, medium, or large. Strawberries (or other fruit) of odd or uneven shapes are correlated to pockets of the series of pockets (30) that are of closest matching shape. The fit-to-size strawberry sizing chart may be used to best approximate where each strawberry should be placed in the series of pockets (30). The user then fills each of the pockets of the series of pockets (30) with melted chocolate to either the first horizontal line (50), the second horizontal line (60), or the third horizontal line (70), depending on the size of the strawberry. If needed, the chocolate must be melted before pouring into each of the series of pockets (30). Next, the user places each strawberry into its correspondingly sized pocket of the series of pockets (30) of the present invention, ensuring that the chocolate level covers most of the strawberry, leaving the stem or leaves exposed. A lid, if included, may be placed atop the tray (10) to ensure that dust or other debris does not contaminate the strawberries. The user then waits for the chocolate to harden, and then may enjoy and share the perfectly chocolate-covered strawberries.

Alternate embodiments of the present invention may be equipped with a lid. The lid is preferably configured to slide along the rim of the tray (10) to close off the series of pockets (30), preventing dust and debris from contaminating the chocolate as it hardens and solidifies during use. Other embodiments of the lid could be configured to snap onto the rim of the tray (10), forming an air-tight seal. Individual lids for each of the pockets of the series of pockets (30) may be fashioned and included with some embodiments of the present invention as well.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A chocolate strawberry dipping device comprising:
a tray;
a series of pockets, said series of pockets disposed on said tray;
at least one grip handle, said at least one grip handle disposed on a side of said tray;
a first horizontal line disposed within each of said series of pockets, said
first horizontal line circumscribing each pocket of the series of pockets;
a second horizontal line disposed within each of said series of pockets, said first horizontal line circumscribing each pocket of the series of pockets;
wherein said second horizontal line is disposed above said first horizontal line; and
wherein said series of pockets are configured to receive strawberries.

2. The device of claim 1, wherein said series of pockets are strawberry-shaped.

3. The device of claim 1, further comprising a third horizontal line; and
wherein said third horizontal line is disposed above said second horizontal line.

4. The device of claim 1, wherein said first horizontal line is a chocolate fill line to be used with small strawberries.

5. The device of claim 4, wherein said second horizontal line is a chocolate fill line to be used with medium-sized strawberries.

6. The device of claim 5, wherein said third horizontal tine is a chocolate fill line to be used with large strawberries.

7. The device of claim 6, wherein said series of pockets molds an embossed design on the chocolate.

8. A method for covering fruits with chocolate comprising:
sizing the fruits by size and shape according to a sizing chart;
melting the chocolate;
filling a series of pockets disposed on a tray with chocolate;
placing the fruits in the series of pockets according to size and shape of the fruits;
wherein the series of pockets are equipped with embossing;
allowing the chocolate to harden; and
removing the fruits and chocolate from the series of pockets.
